(19) United States
(12) Patent Application Publication
(10) Pub. No.: US 2024/0010525 A1
(43) Pub. Date: Jan. 11, 2024

(54) METHODS OF OBTAINING WATER FOR DOWNSTREAM PROCESSES

(71) Applicant: BASF Corporation, Florham Park, NJ (US)

(72) Inventors: Jack Bender, Tucson, AZ (US); Tinoush Dinn, Beachwood, OH (US); William C. Mays, Southfield, MI (US); Martin Lawrence Panchula, Beachwood, OH (US); Dieter G. Von Deak, Beachwood, OH (US)

(21) Appl. No.: 18/035,229

(22) PCT Filed: Nov. 4, 2021
(86) PCT No.: PCT/US2021/072233

§ 371 Date: May 3, 2023

Related U.S. Application Data
(60) Provisional application No. 63/109,421, filed on Nov. 4, 2020.

(51) Int. Cl. C02F 1/42; C02F 1/26

(52) U.S. Cl. CPC C02F 1/42; C02F 1/26; C02F 2101/20

(57) ABSTRACT

Disclosed herein are processes for isolating purified water from a waste stream, such as, e.g., a waste stream formed in the manufacture or recycling of batteries, and further e.g., processes for isolating purified water suitable for use in downstream industrial processes from a waste stream generated during delithiation of a lithium metal oxide material.

This application claims the benefit of priority of U.S. Provisional Application No. 63/109,421, filed Nov. 4, 2020, the contents of which are herein incorporated by reference in their entirety.

Disclosed herein are processes for isolating purified water from a waste stream, such as, e.g., a waste stream formed in the manufacture or recycling of batteries. Also disclosed herein are processes for isolating purified water suitable for use in downstream industrial processes from a waste stream formed during the delithiation of a lithium metal oxide material (e.g., LiMO₂, wherein M is chosen from metals).

Lithium-ion batteries are increasingly used in essential applications, including, e.g., powering electric vehicles, cellular telephones, and cameras. Their increased application in wide-ranging technological fields has created a heightened need for cost-effective mechanisms of producing and/or recycling lithium-ion batteries. For example, industrial processes such as battery manufacture require process water that will not interfere with the necessary manufacturing reactions. While the use of recycled waste water in these processes would reduce overall manufacturing costs and make battery manufacture more environmentally friendly, high levels of nickel and lithium, as well as other acids and contaminants, in waste streams formed during the production of lithium-ion batteries or the recycling of spent lithiated batteries limit the utility of these waste materials in downstream processes. Thus, there is a need in the art for methods of purifying waste water that permit its reuse in industrial processes.

Delithiation processes typically use oxidizers that generate a large amount of waste that must be processed, increasing clean-up time and process costs. Moreover, recycling methods employing oxidizers may not provide for effective separation of the extracted components, thereby making individual recovery of desired materials impracticable. Such deficiencies decrease the amount of material that may be recovered and increase both the amount of waste produced and the costs associated with extraction of contaminants from an aqueous waste stream. Accordingly, novel waste water purification processes are needed to improve efficiency and increase the output of purified process water for use in downstream industrial processes.

Provided herein is a process for isolating purified water comprising:
subjecting an aqueous solution comprising a metal (M) and/or lithium (Li⁺) to a solvent extraction process or ion exchange process in the presence of a metal extractant under conditions suitable to remove a portion of the metal and/or a portion of the lithium from the aqueous solution to form a metal poor solution.

In some embodiments, the aqueous solution comprises a metal (M) and lithium (Li⁺).

In some embodiments, the lithium is monovalent lithium ion and/or a salt thereof.

In some embodiments, the metal comprises a transition metal and/or a post-transition metal. In some embodiments, the metal is chosen from Al, Bi, Ni, Ca, Co, Cr, Cu, Fe, In, La, Mg, Mn, Ru, Sb, Sn, Ti, Ba, Si, Sr, Zn, and combinations of any of the foregoing. In some embodiments, the metal is Ni. In some embodiments, the metal is divalent Ni.

In some embodiments, a portion of the metal and a portion of the lithium are removed by solvent extraction or ion exchange.

In some embodiments, the metal extractant is not specific for the metal or lithium.

In some embodiments, the metal extractant is an oxime. In some embodiments, the metal extractant is chosen from aldoximes and ketoximes. In some embodiments, the metal extractant is chosen from 5-nonylsalicylaldoxime, 5-dodecylsalicylaldoxime, 5-nonyl-2-hydroxyacetophenone oxime, and combinations of any of the foregoing.

In some embodiments, the metal extractant is a carboxylic acid.

Also provided herein is a process for isolating purified water comprising:
treating an aqueous solution comprising a metal (M), and optionally lithium (Li⁺), with an amount of an alkaline agent sufficient to convert a portion of the metal to an insoluble metal salt to form a metal poor solution.

In some embodiments, the lithium is monovalent lithium ion and/or a salt thereof.

In some embodiments, the metal comprises a transition metal and/or a post-transition metal. In some embodiments, the metal is chosen from Al, Bi, Ni, Ca, Co, Cr, Cu, Fe, In, La, Mg, Mn, Ru, Sb, Sn, Ti, Ba, Si, Sr, Zn, and combinations of any of the foregoing. In some embodiments, the metal is Ni. In some embodiments, the metal is divalent Ni.

In some embodiments, the alkaline agent selectively forms the insoluble metal salt such that the metal poor solution is not lithium depleted.

In some embodiments, the alkaline agent forms metal and lithium salts with lower solubility in water than the metal and lithium in the aqueous solution.

In some embodiments, the alkaline agent is chosen from sodium hydroxide, potassium hydroxide, ammonium hydroxide, and a combination of at least two of the foregoing.

In some embodiments, the alkaline agent is not a calcium salt. In some embodiments, the alkaline agent is not a potassium salt. In some embodiments, the alkaline agent is not a calcium salt or a potassium salt.

In some embodiments, the process further comprises contacting the metal poor solution with a lithium salt forming agent to form a lithium poor solution.

In some embodiments, the lithium salt forming agent forms a carbonate of lithium, a silicate of lithium, an orthosilicate of lithium, or an alkylcarboxylic acid.

In some embodiments, the lithium salt forming agent is chosen from ammonia, carbon dioxide, sodium carbonate, ammonium carbonate, and combinations of any of the foregoing.

Also provided herein is a process for isolating purified water comprising:
contacting an aqueous solution comprising lithium (Li⁺), and optionally a metal (M), with a lithium salt forming agent to form a lithium poor solution.

In some embodiments, the lithium salt forming agent forms a carbonate of lithium, a silicate of lithium, an orthosilicate of lithium, or an alkylcarboxylic acid.

In some embodiments, the lithium salt forming agent is chosen from ammonia, carbon dioxide, sodium carbonate, ammonium carbonate, and combinations of any of the foregoing.

In some embodiments of any process of the disclosure, the process further comprises removing at least some acid from the metal poor solution or the lithium poor solution.

In some embodiments, removing at least some acid comprises contacting the metal poor solution or the lithium poor solution with an acid removing agent. In some embodiments, the acid removing agent is a base. In some embodiments, the acid removing agent does not increase the difficulty of extracting lithium from a solution. In some embodiments, the acid removing agent is lithium hydroxide.

In some embodiments, contact with the acid removing agent results in isolation of purified water with a pH between 4.0 and 9.0. In some embodiments, contact with the acid removing agent results in isolation of purified water with a pH between 4.0 and 7.0. In some embodiments, contact with the acid removing agent results in isolation of purified water with a pH between 7.0 and 9.0. In some embodiments, contact with the acid removing agent results in isolation of purified water with a pH between 7.0 and 8.0.

In some embodiments, contact with the acid removing agent results in isolation of purified water with a pH of no greater than 9.0. In some embodiments, contact with the acid removing agent results in isolation of purified water with a pH of no greater than 8.0.

In some embodiments of any process of the disclosure, the metal poor solution, the lithium poor solution, or both are subjected to a salt removal process, before or after removing at least some acid from the solution.

In some embodiments, the salt removal process is reverse osmosis, electrolysis, temperature swing extraction, or ion exchange.

In some embodiments, the salt removal process removes at least some chloride salts.

In some embodiments of any process of the disclosure, the metal poor solution or the lithium poor solution comprises less than 1000 parts per million of the metal. In some embodiments of any process of the disclosure, the metal poor solution or the lithium poor solution comprises less than 100 parts per million of the metal. In some embodiments of any process of the disclosure, the metal poor solution or the lithium poor solution comprises less than 10 parts per million of the metal.

In some embodiments of any process of the disclosure, the metal poor solution or the lithium poor solution comprises less than 1000 parts per million Li⁺. In some embodiments of any process of the disclosure, the metal poor solution or the lithium poor solution comprises less than 100 parts per million Li⁺. In some embodiments of any process of the disclosure, the metal poor solution or the lithium poor solution comprises less than 10 parts per million Li⁺.

In some embodiments of any process of the disclosure, the aqueous solution is waste from a delithiation reaction. In some embodiments, the delithiation reaction comprises delithiating a compound comprising LiNiO₂ to form the aqueous solution.

In some embodiments of any process of the disclosure, the aqueous solution comprises lithium and a metal. In some embodiments of any process of the disclosure, the aqueous solution comprises lithium and nickel.

In some embodiments of any process of the disclosure, the purified water isolated using the process comprises less than 1000 parts per million of the metal. In some embodiments of any process of the disclosure, the purified water isolated using the process comprises less than 100 parts per million of the metal. In some embodiments of any process of the disclosure, the purified water isolated using the process comprises less than 10 parts per million of the metal.

In some embodiments of any process of the disclosure, the purified water isolated using the process comprises less than 1000 parts per million Li⁺. In some embodiments of any process of the disclosure, the purified water isolated using the process comprises less than 100 parts per million Li⁺. In some embodiments of any process of the disclosure, the purified water isolated using the process comprises less than 10 parts per million Li⁺.

In some embodiments of any process of the disclosure, the purified water isolated using the process comprises less than 1000 parts per million dissolved salt. In some embodiments of any process of the disclosure, the purified water isolated using the process comprises less than 100 parts per million dissolved salt. In some embodiments of any process of the disclosure, the purified water isolated using the process comprises less than 10 parts per million dissolved salt.

In some embodiments of any process of the disclosure, the purified water isolated using the process comprises less than 1000 parts per million acid.

In some embodiments of any process of the disclosure, the purified water isolated using the process has a pH between 7.0 and 9.0. In some embodiments of any process of the disclosure, the purified water isolated using the process has a pH of 8.0 or less. In some embodiments of any process of the disclosure, the purified water isolated using the process has a pH of 8.0.

In some embodiments of any process of the disclosure, the purified water isolated using the process is used in a delithiation reaction comprising delithating a lithium-containing compound. In some embodiments, the lithium-containing compound comprises LiNiO₂.

### NON-LIMITING EXAMPLE EMBODIMENTS

Without limitation, some embodiments of the disclosure include:
1. A process for preparing purified process water from waste of a reaction delithiating lithium containing metal particles comprising:
   (A) providing a M/Li⁺ solution as waste from a delithiation reaction, said solution comprising an amount of lithium and an amount of M;
   (B) subjecting said M/Li⁺ solution to solvent extraction or ion exchange in the presence of a metal extractant under conditions suitable to remove M and Li⁺ from the M/Li⁺ solution to form a metal poor solution; and optionally
   (C) contacting said metal poor solution with an acid removing agent;
      thereby producing a purified process water.
2. A process for preparing purified process water from waste of a reaction delithiating lithium containing metal particles comprising:
   (A) providing a M/Li⁺ solution as waste from a delithiation reaction, said solution comprising an amount of lithium and an amount of nickel;
   (B) treating the M/Li⁺ solution with an alkaline agent at sufficient levels to covert M to an insoluble metal salt, thereby producing a metal poor solution, contacting the M/Li⁺ solution or the metal poor solution with a lithium salt forming agent to form said metal poor solution, or both said treating and said contacting; and optionally
   (C) removing acid remaining in said metal poor solution to thereby form purified process water.
3. A process for preparing purified process water from waste of a reaction delithiating lithium containing metal particles comprising:
   (A) providing a M/Li⁺ solution as waste from a delithiation reaction, said solution comprising an amount of lithium and an amount of M;
   (B) treating the M/Li⁺ solution with an alkaline agent at sufficient levels to covert M to an insoluble metal salt, thereby producing a metal poor solution;
   (C) contacting the metal poor solution with a lithium salt forming agent to form lithium poor solution; and optionally
   (D) removing acid remaining in said lithium poor solution to thereby form purified process water.
4. The process of any one of Embodiments 1-3, wherein the metal poor solution comprises less than 1000 parts per million M, optionally less than 100 parts per million M, optionally less than 10 parts per million M.
5. The process of any one of Embodiments 1-3, wherein the metal poor solution or the lithium poor solution comprises less than 1000 parts per million Li⁺, optionally less than 100 parts per million Li⁺, optionally less than 10 parts per million Li⁺.
6. The process of any one of Embodiments 1-5, wherein the metal poor solution or the lithium poor solution is contacted with an acid removing agent, said acid removing agent optionally selective for removing acid leaving a purified water with a pH of no greater than 8.0.
7. The process of any one of Embodiments 1-5, wherein said M and said Li⁺ is removed by solvent extraction or ion exchange.
8. The process of any one of Embodiments 1 or 3-5, wherein said metal extractant is non-specific for M or Li⁺.
9. The process of any one of Embodiments 2-5, wherein said alkaline agent selectively forms the insoluble metal salt such that the metal poor solution is depleted with M alone.
10. The process of any one of Embodiments 2-5, wherein said alkaline agent is provided at a suitable concentration to form both M and Li⁺ salts with lower solubility in water than the M and Li⁺ species in the M/Li⁺ solution.
11. The process of any one of Embodiments 2-5, wherein the alkaline agent is selected from the group consisting of sodium hydroxide, potassium hydroxide, ammonium hydroxide, and a combination of at least two of the foregoing.
15. The process of any one of Embodiments 2-5, wherein the lithium salt forming agent forms a carbonate, silicate, or orthosilicate of lithium, or an alkylcarboxylic acid.
16. The process of any one of Embodiments 1-15, wherein said metal poor solution, lithium poor solution, or both are treated subjected to a salt removal process.
17. The process of Embodiment 16, wherein said salt removal process removes chloride salts.
18. The process of Embodiment 16 or 17, wherein said salt removal process is reverse osmosis, electrolysis, temperature swing extraction, or ion exchange.
19. The process of any one of Embodiments 16-18, further comprising subjecting said metal poor solution, lithium poor solution, or both are subjected to a salt removal process and treatment with an acid removing agent.
20. The process of any one of Embodiments 1-19, wherein said purified process water comprises:
   a. less than 1000 parts per million M (optionally N²⁺) optionally less than 100 parts per million M, optionally less than 10 parts per million M;
   b. less than 1000 parts per million Li⁺, optionally less than 100 parts per million Li⁺, optionally less than 10 parts per million Li⁺;
   c. less than less than 1000 parts per million dissolved salt, optionally less than 100 parts per million dissolved salt, optionally less than 10 parts per million dissolved salt; or
   d. less than 1000 parts per million acid or with a pH of 7.0 to 9.0, optionally about 8.0.
21. The process of Embodiment 20, wherein said purified process water comprises all of a-d.
22. The process of Embodiments 20 or 21, wherein said purified process water has a pH of 8.0 or less.
23. The process of any one of Embodiments 1-22, wherein prior to step (A) the process further comprises delithiating a compound comprising LiNiO₂ to form said M/Li⁺ solution comprising Ni²⁺ and Li⁺.
24. The process of any one of Embodiments 1-23, further comprising using said purified process water in a delithiation reaction for delithating a lithium containing compound.
25. The process of Embodiment 24, wherein said lithium containing compound comprises LiNiO₂.

Some embodiments of the disclosure relate to processes of producing purified process water from a waste stream that includes lithium and one or more metals. The processes result in purified process water that has less than 1000 parts per million Li⁺, less than 1000 parts per million of a metal (M), and/or suitable low levels of acid or dissolved salts so as to be useful for downstream industrial processes. Many industrial processes require process water that is substantially free of contaminants so as to effectively be used in the desired reactions. This disclosure provides processes of producing such purified process water. While this disclosure is generally directed to the purification of water produced from a delithiation reaction employing lithiated metal oxide materials, the processes may be equally applied to any waste stream that includes lithium alone or with one or more other metals.

As such, provided herein are processes of producing purified process water from a waste stream. In some embodiments, the waste stream includes lithium, optionally in the form of a monovalent Li ion or salt thereof, alone or in combination with one or more metals illustrated herein by the letter “M.” M may be any transition metal or post-transition metal. In some embodiments, M may be any metal used in the manufacture of batteries, such as, e.g., the manufacture of secondary batteries. Optionally, M may be Al, Bi, Ni, Ca, Co, Cr, Cu, Fe, In, La, other rare earths, Mg, Mn, Ru, Sb, Sn, Ti, Ba, Si, Sr, Zn, or any combination thereof. Optionally, M is Al, Ni, Co, Mn, Mg, or any combination thereof. In some embodiments, M is Ni. The metal M is typically present as a monovalent, divalent, trivalent, or other metal ion. As an illustrative non-limiting example, M may be divalent Ni.

The processes provided herein allow for efficient and robust separation of lithium and one or more metals from waste or recycling streams such that the resulting purified process water may be used for subsequent processes or for the formation of additional electrochemically active materials. The processes provided herein operate by solvent extraction, ion exchange, salt formation and precipitation, or combinations thereof.

In general, a waste material is provided as a source of Li and M, optionally Ni, for extraction or isolation by the processes as provided herein. The term “waste,” as used herein, refers to a liquid or solid composition that includes both M and Li⁺, with either or both at a concentration suitable for extraction. As used herein, “waste” is not required to be a composition which is a used product of another prior process, but may be the result of an upstream process, such as, e.g., the leaching of M or Li from a prior processing step of a desired material. Optionally, waste as used herein is a waste stream from a continuous or discontinuous leaching of M and Li as produced during the delithiation of a lithium nickel oxide with a mineral acid, such as, e.g., that used for the formation of a cathode in a primary or secondary electrochemical cell.

As used herein, “ppm” or “parts per million” refers to milligrams per liter (mg/L).

In some embodiments, a process for preparing purified process water from waste of a reaction delithiating lithium containing metal particles is provided that includes: providing a M/Li⁺ solution as waste from a delithiation reaction, the M/Li⁺ solution including an amount of lithium and an amount of M; and subjecting the M/Li⁺ solution to solvent extraction or ion exchange in the presence of a metal extractant under conditions suitable to remove M and Li⁺ from the M/Li⁺ solution to form a metal poor solution.

In performing these processes, one may generate a pH isotherm with any solvent extraction reagent or ion exchange resin for any desired M or Li in the waste stream. The extractants used for these processes are based on the metal speciation in the waste stream. For example, any waste stream can be analyzed for the ion composition by processes known in the art, illustratively inductively coupled plasma (ICP) analyses. The metal speciation can be readily determined using the Pourbaix diagram for the metals in the relevant matrix. Alternatively, one of ordinary skill in the art readily is able to make a Pourbaix diagram for the metals in solution for any matrix. After the chemical species in the matrix are understood through simple calculation, the suitability of any desired extractant can be readily determined by creating organic phase and extraction isotherms. For example, a quick pH extraction isotherm can be generated for any waste stream for any desired extractant. One can then use this to determine the amount of any extractant necessary to extract the Li or M from the waste stream. In some embodiments, the extractant may be combined with the waste stream, and the M and Li may be removed by solvent extraction steps or through the use of an ion exchange media.

Alternatively or in addition, one may produce a purified process water by: providing a M/Li⁺ solution as waste from a delithiation reaction, the M/Li⁺ solution including an amount of lithium and an amount of nickel; and treating the M/Li⁺ solution with an alkaline agent at sufficient levels to covert M to an insoluble metal salt, thereby producing a metal poor solution, contacting the M/Li⁺ solution or the metal poor solution with a lithium salt forming agent to form the metal poor solution or a lithium poor solution, or both the referred to treating and contacting. In the formation of insoluble salts from the solution, the amount of alkaline agent is chosen to either selectively or non-selectively form the insoluble salts to precipitate the M or Li from the solution. For example, if M is Ni and the solution includes Ni in as the divalent metal Ni²⁺, one can add a sufficient amount of alkaline agent to covert the divalent Ni to the insoluble metal salt. The amount of base required is readily calculated for any metal species.

Precipitation of Li⁺ presents its own considerations for precipitation. As lithium is a small ion pair relative to metals, lithium has a much higher solubility in aqueous solvents. Thus, to precipitate the lithium, one may form a lithium salt that has far less solubility than the lithium ion originally in the solution, whereby the new lithium salt can be readily removed from solution. In some embodiments, a carbonate of lithium is formed. For example, relative to lithium hydroxide, which has a solubility of ˜12-13 g/100 mL of water, lithium carbonate has a water solubility of 1.54 g/100 mL, which is much more readily precipitated from solution. Alternatively, or in addition, silicates of orthosilicates of Li can be formed that are substantially insoluble and readily removed from solution. The species that will precipitate Li may also precipitate other metals in the waste stream solution. Thus, in some embodiments, both M and Li may be removed at the same time by the same species.

In other embodiments, a process for preparing purified process water from waste of a reaction delithiating lithium containing metal particles is or includes a selective and stepwise separation of metals and lithium to produce the purified water. As a non-limiting example, the process optionally comprises: providing a M/Li⁺ solution as waste from a delithiation reaction, the solution including an amount of lithium and an amount of M; treating the M/Li⁺ solution with an alkaline agent at sufficient levels to covert M to an insoluble metal salt, thereby producing a metal poor solution; and contacting the metal poor solution with a lithium salt forming agent to form lithium poor solution. The lithium salt forming agent may optionally produce a lithium carbonate that is then precipitated by the presence of the alkaline agent in the material. For example, the M species may be selectively removed by addition of a suitable amount of alkaline agent to form the metal salt that is separated from the solution. Then, the metal poor solution is combined with a lithium salt forming agent such as a carbonate, silicate, or orthosilicate that is then removed from the metal poor solution to produce the purified water.

Any of the water products of Li and M removal may be further processed to either adjust the pH, selectively or non-selectively remove acid, and/or remove other salt species from the products to produce further purified water. Such further processes optionally include addition of a selective acid removing agent to the system such as a tertiary amine. Other processes of selectively removing acid can be found in Bender, et al., “Acid removal by solvent extraction for use in electrolyte to neutral aqueous systems,” presented at ALTA 2020. Optionally, an acid removing agent leaves purified process water with characteristics suitable for use in downstream processes, optionally for delithiation of a LiNiO₂ material. In some embodiments, the acid removing agent optionally produces a pH of the purified process water of about 4.0 to about 9.0, optionally about 4.0 to about 7.0, optionally about 7.0 to about 9.0, or optionally about 7.0 to about 8.0. In some embodiments, treatment with an acid removing agent leaves a purified process water with a pH of 9.0 or less, optionally 8.0 or less.

Alternatively, the metal poor solution, lithium poor solution, or both may be subjected to reverse osmosis, electrolysis, temperature swing extraction, or ion exchange to remove residual dissolved salts (e.g., non-M, non-Li salts).

The lithium present in the M/Li⁺ solution may be derived from any suitable lithium-containing and any suitable metal-containing compound. Illustratively, a M/Li⁺ solution may be a waste stream as the result of delithiation of an electrochemically active material used in electrochemical cells and produced according to delithiation methods recognized in the art of illustratively, LiNiO₂ materials, NCM materials, or others. Optionally, the M/Li⁺ solution results from the delithiation of LiMO₂ materials, wherein M is any of one of many metals such as Mn, Mg, Al, Co, and/or most any other transition or post-transition metal, or Mg. Other non-limiting examples include LiNiCoAlO₂, LiNiCoAlMO₂, wherein M is optionally a transition metal, Mg, or other. A transition metal may be any transition metal suitable for use in an electrochemical cell. Illustrative examples of a transition metal include, but are not limited to, Ni, Co, Mn, Al, Mg, Ti, Zr, Nb, Hf, V, Cr, Sn, Cu, Mo, W, Fe, Si, B, or other transition metals.

The production of electrochemically active materials or the other production of a M/Li⁺ solution may be by the combination of a lithium compound and a metal compound. Optionally, a lithium compound is a lithium hydroxide, lithium oxide, lithium carbonate, lithium nitrate, lithium sulfate, lithium acetate, lithium peroxide, lithium hydrogen carbonate, or a lithium halide, or any combination thereof.

In some embodiments, the amount of lithium present in the M/Li⁺ solution may range from about 5 g/L to about 250 g/L, optionally from about 20 g/L to about 150 g/L. In some embodiments, the amount of lithium present in the M/Li⁺ solution is from about 10 g/L to about 200 g/L, about 15 g/L to about 175 g/L, about 20 g/L to about 150 g/L, about 25 g/L to about 125 g/L, about 30 g/L to about 100 g/L, about 40 g/L to about 75 g/L, or about 50 g/L to about 60 g/L.

In some embodiments, the metal present in the M/Li⁺ solution may be derived from any suitable metal-containing compound such as hydroxide, oxide, oxyhydroxide, carbonate, or nitrate of the metal.

In some embodiments, the amount of metal present in the M/Li⁺ solution may range from about 5 g/L to about 400 g/L, optionally from about 20 g/L to about 200 g/L. In some embodiments, the amount of metal present in the M/Li⁺ solution is from about 10 g/L to about 300 g/L, about 15 g/L to about 250 g/L, about 20 g/L to about 200 g/L, about 25 g/L to about 150 g/L, about 30 g/L to about 100 g/L, about 40 g/L to about 75 g/L, or about 50 g/L To about 60 g/L.

A LiMO₂ material may be delithiated in such a way so as to yield a waste stream with Li and M that may be isolation per the processes as described herein to produce a purified process water. Optionally, delithiation is performed substantially by processes as recognized in the art, illustratively those processes described in U.S. Pat. No. 8,298,706, such as, e.g., by subjecting the LiMO₂ materials to aqueous hydrochloric acid or perchloric acid at a desired delithiation temperature. The aqueous acid solution can have a concentration of 1 mole/liter or more (e.g., 3 moles/liter or more, 6 moles/liter or more, 8 moles/liter or more, or 10 moles/liter or more) and/or 12 moles/liter or less (e.g., 10 moles/liter or less, 8 moles/liter or less, 6 moles/liter or less, or 3 moles/liter or less). Optionally, the concentration of the aqueous acid solution can be between 0.1 moles/liter and 10 moles/liter (e.g., between 1 moles/liter and 10 moles/liter, or between 4 moles/liter and 8 moles/liter). Optionally, a delithiation temperature is between 0° C. and 5° C. In some embodiments, a delithiation temperature is 10 DC or greater, optionally 60° C. or greater. The resulting slurry is mixed at the delithiation temperature for about 20-40 hours, and the solids are allowed to settle, followed by isolation and washing of the solid delithiated material for use in cathode production. The removed supernatant from the wash may be used as a waste stream M/Li⁺ solution in the further embodiments of the processes as provided herein.

In some embodiments, the process for producing purified process water includes treating the M/Li⁺ solution with an alkaline agent in an amount suitable to precipitate the metal species, such as, e.g., by formation of insoluble metal or lithium salts. Suitable alkaline agents may include, but are not limited to, calcium oxide, sodium hydroxide, potassium hydroxide, ammonium hydroxide, lithium hydroxide, or combinations thereof. Optionally, an alkaline agent excludes agents that will introduce into the system a cation that will confound separation of one or more metals from the desired solution. Optionally, an alkaline agent excludes a sodium salt. Optionally, an alkaline agent excludes a potassium salt. Optionally, an alkaline agent excludes a calcium salt.

Optionally, a M/Li⁺ solution is treated with one or more metal extractants under conditions suitable to remove M and Li⁺ from the M/Li⁺ solution to form a metal poor solution. A metal extractant is optionally an oxime. Illustrative oximes include, but are not limited to, aldoximes and ketoximes. Such oximes are illustratively described by the following formula I:

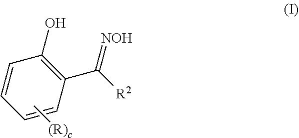

wherein:
each R is an alkyl group having from 1 to 25 carbon atoms, an ethylenically unsaturated aliphatic group containing from 3 to 25 carbon atoms, or —OR¹, wherein:
   R¹ is an alkyl group or ethylenically unsaturated aliphatic group as defined above;
c is 1, 2, 3, or 4; and
R² is H, an alkyl group containing 1 to 25 carbon atoms, an ethylenically unsaturated aliphatic group containing 3 to 25 carbon atoms, or

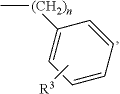

wherein:
n is 0 or 1; and
R³ is an alkyl group having from 1 to 25 carbon atoms, an ethylenically unsaturated aliphatic group containing from 3 to 25 carbon atoms, or —OR¹, wherein:
   R¹ is an alkyl group or ethylenically unsaturated aliphatic group as defined above.

In some embodiments, oximes are illustratively described by the following formula Ia:

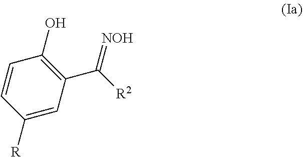

wherein:
R is an alkyl group having from 1 to 25 carbon atoms, an ethylenically unsaturated aliphatic group containing from 3 to 25 carbon atoms, or —OR¹, wherein:
   R¹ is an alkyl group or ethylenically unsaturated aliphatic group as defined above; and
R² is H, an alkyl group containing 1 to 25 carbon atoms, an ethylenically unsaturated aliphatic group containing 3 to 25 carbon atoms, or

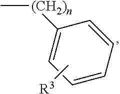

wherein:
n is 0 or 1; and
R³ an alkyl group having from 1 to 25 carbon atoms, an ethylenically unsaturated aliphatic group containing from 3 to 25 carbon atoms, or —OR¹, wherein:
   R² is an alkyl group or ethylenically unsaturated aliphatic group as defined above.

In some embodiments, the total number of carbon atoms in the R and R³ groups in Formula (I) or Formula (Ia) is from 3 to 25. Such oximes are as described in U.S. Pat. Nos. 6,261,526 and 8,986,633.

Suitable illustrative specific oximes may include, but are not limited to, an aldoxime such as 5-nonylsalicylaldoxime, 5-dodecylsalicylaldoxime, or a ketoxime, such as, e.g., 5-nonyl-2-hydroxyacetophenone oxime. Optionally more than one oxime or oxime type are combined.

In some embodiments, a metal extractant is a carboxylic acid. Optionally, a carboxylic acid is a tertiary carboxylic acid, optionally a branched tertiary carboxylic acid. Optionally, the carboxylic acid includes one or more alkyl radicals linked to the carboxylic acid group. An alkyl radical is optionally a C1-C10 alkyl radical, optionally C1-C9. Optionally, three alkyl radicals are linked to a central carbon linked to the carboxylic acid group. In some embodiments, each of the three alkyl radicals are independently optionally C1-C10 alkyl. Optionally, a first alkyl radical is a methyl. Optionally, a second alkyl is a C1-C10 alkyl. Optionally, a third alkyl is a C1-C5 alkyl. Each alkyl may be linear or branched.

In some embodiments, a carboxylic acid metal extractant is neodecanoic acid.

In some embodiments, the metal extractant may be added in one or more extraction stages in a solvent extraction process to the M/Li⁺ solution from about 5 percent by volume to about 50 percent by volume, based on the total volume of the M/Li⁺ solution. Other suitable ranges of the metal extractant may include, but are not limited to, from about 10 percent by volume to about 45 percent by volume, from about 15 percent by volume to about 40 percent by volume, or from about 20 percent by volume to about 30 percent by volume, based on the total volume of the M/Li⁺ solution.

In some embodiments, a metal extractant is non-selective for M or Li⁺. Such extractants are optionally alkaline agents such as calcium oxide, sodium hydroxide, potassium hydroxide, ammonium hydroxide, lithium hydroxide, or combinations thereof. An alkaline agent is optionally provided at an amount suitable to precipitate one or more of M or Li⁺ from the solution. An alkaline agent is optionally provided at a suitable concentration to form both M and Li⁺ salts with lower solubility in water than the M and Li⁺ species in the M/Li⁺ solution.

In some embodiments, a metal poor solution or the M/Li⁺ solution is treated with a lithium salt forming agent to deplete lithium from the solution. In some embodiments, the lithium salt forming agent forms a carbonate, silicate, or orthosilicate of lithium or is a carboxylic acid suitable for selectively precipitating lithium. Illustrative lithium salt forming agents may include, but are not limited to, carbon dioxide plus ammonia, carbon dioxide, sodium carbonate, ammonium carbonate, or combinations thereof. The lithium salt forming agent may be contacted with the metal poor solution or M/Li⁺ solution in a chamber and allowed to incubate at a desired time and for a desired temperature, optionally, e.g., −5° C. to 120° C., to allow formation of a lithium carbonate salt. In some embodiments, a lithium salt forming agent is a silicate or orthosilicate that will form lithium silicate or lithium orthosilicate upon incubation with lithium hydroxide. Solutions of silica may be prepared in the lithium hydroxide containing metal poor solution or M/Li⁺ solution to form the insoluble lithium silicate and separated substantially as described in U.S. Pat. No. 3,576,597.

In some embodiments, a lithium salt forming agent is a carboxylic acid. Optionally, a lithium salt forming agent is a tertiary carboxylic acid, optionally a branched tertiary carboxylic acid. Optionally, the carboxylic acid includes one or more alkyl radicals linked to the carboxylic acid group. An alkyl radical is optionally a C1-C10 alkyl radical, optionally C1-C9. Optionally, three alkyl radicals are linked to a central carbon linked to the carboxylic acid group. Each of the three alkyl radicals are independently optionally C1-C10 alkyl. Optionally, a first alkyl radical is a methyl. Optionally, a second alkyl is a C1-C10 alkyl. Optionally, a third alkyl is a C1-C5 alkyl. Each alkyl may be linear or branched. In some embodiments, the lithium salt forming agent is neodecanoic acid.

In some embodiments, the process for forming purified process water from a M/Li⁺ solution further includes treating the M/Li⁺ solution or the metal poor solution with a lithium selective extractant, wherein the lithium selective extractant is suitable to extract lithium from the M/Li⁺ solution or metal poor solution to thereby produce a lithium poor solution with less Li that the M/Li⁺ solution.

In some embodiments, a lithium selective extractant is added to 10% to 40% v/v, optionally 10% to 30% v/v, optionally 15% to 25% v/v. In some embodiments, the lithium selective extractant is added at a volume percent of 10%, 15%, 20%, 25%, or 30%. The solution of lithium selective extractant is optionally added to the forgoing volume percent from a substantially purified or saturated solution of the lithium selective extractant.

A lithium selective extractant is optionally an anion-containing extractant capable of extracting Li into an organic phase. Illustrative examples of such lithium selective extractants include, but are not limited to, 2-hydroxy-5-nonylacetophenone oxime (LIX 84-I), LIX 54-100, LIX 55 (BASF), CYANEX 936 (SOLVAY) and CYANEX 923 (SOLVAY) that is a mixture of four trialkylphosphine oxides R^{3P}(O), R²R′P(O), RR′₂(O), and R′₃P(O), wherein R is a linear C₈-alkyl radical and R′ is a linear C₆-alkyl radical, or any blend of two or more of any of these reagents. In some embodiments, the lithium selective extractant is an acid. Suitable acids include, but are not limited to, a 2-ethylhexyl phosphonic acid mono-2-ethylhexyl ester, neodecanoic acid, or combinations thereof.

The lithium selective extractant may be added to the M/Li⁺ solution or the metal poor solution from about 5 percent by volume to about 50 percent by volume, based on the total volume of the solution to which the lithium selected extractant is added. Other suitable ranges of the lithium selective extractant may include, but are not limited to, from about 10 percent by volume to about 45 percent by volume, from about 15 percent by volume to about 40 percent by volume, or from about 20 percent by volume to about 30 percent by volume.

In some embodiments of the disclosure, the lithium selective extractant further optionally includes a hydrocarbon as a diluent. Suitable hydrocarbons may include, but are not limited to, kerosene, paraffin, naphthene, or combinations thereof. The lithium selective extractant and hydrocarbon may be present together at varying ratios. Optionally, ratios of lithium-selective extractant to hydrocarbon may range from about 1:99 by volume to about 99:1. Optionally, the lithium selective extractant to hydrocarbon ratio is about 50:50 by volume, optionally 20:80 by volume. Optionally, the lithium selective extractant to hydrocarbon ratio is from about 2:98 percent by volume to about 45:55 by volume, about 3:97 by volume to about 40:60 by volume, about 5:95 by volume to about 40:60 by volume, about 7:93 by volume to about 35:65 by volume, or about 10:90 by volume to about 30:70 by volume, wherein each of the lithium selective extractant and hydrocarbon are from, respectively, a substantially isolated or saturated solution of the lithium selective extractant or hydrocarbon.

The processes as provided herein optionally include one or more extraction stages in series or in parallel. Optionally, the number of extraction stages where the alkaline agent, lithium selective extraction agent, metal extraction agent, or other contacts the M/Li⁺ solution is 1, 2, 3, 4, 5, 6, 7, or more stages. The multi-staging of the processes as provided herein provides rapid and robust extraction of metal and lithium from the M/Li⁺ solution. The results of the one or more extraction stages is a metal poor solution or a lithium poor solution. The metal poor solution, the lithium poor solution (or result of the lithium extraction), or both is optionally less than or equal to 1000 ppm Li⁺, 500 ppm Li⁺, 100 ppm Li⁺, 10 ppm Li⁺, 9 ppm Li⁺, 8 ppm Li⁺, 7 ppm Li⁺, 6 ppm Li⁺, 5 ppm Li⁺, 4 ppm Li⁺, 3 ppm Li⁺, 2 ppm Li⁺, or 1 ppm Li⁺. The metal poor solution, the lithium poor solution (or result of the lithium extraction), or both is optionally less than or equal to 1000 ppm M, 500 ppm M, 100 ppm M, 10 ppm M, 9 ppm M, 8 ppm M, 7 ppm M, 6 ppm M, 5 ppm M, 4 ppm M, 3 ppm M, 2 ppm M, or 1 ppm M.

Following removal from the M/Li⁺ solution, the resulting M product, Li product, or both may be subsequently filtered and washed so as to form a metal precipitate, lithium carbonate, or lithium hydroxide that may be directly utilized for subsequent production of materials, optionally for the production of lithiated cathode electrochemically active materials.

The purified process water is optionally subjected to nanofiltration or other process to further remove other dissolved salts within the process water. Optionally, the purified process water is subjected to a salt removal process. A salt removal process optionally selectively or non-selectively removes chloride salts such as sodium chloride, potassium chloride, or other chloride salt. In some embodiments, a purified process water sample is subjected to reverse osmosis. Reverse osmosis may remove 99 wt % or greater dissolved salts that remain in the purified process water. Other mechanisms by which dissolved salts may be removed, if desired, include temperature swing extraction or ion exchange.

The resulting purified process water is optionally used in one or more downstream industrial processes. Optionally, the purified process water is used as a solvent for a subsequent delithiation reaction, or for any other desired industrial process.

Various modifications of the present disclosure, in addition to those shown and described herein, will be apparent to those skilled in the art in view of the above description. Such modifications are also intended to fall within the scope of this disclosure.

It will further be appreciated by skilled artisans that all reagents are obtainable by sources known in the art unless otherwise specified.

This description of particular aspects/embodiments is merely exemplary in nature and is in no way intended to limit the scope of the disclosure or its applications or uses, which may vary. Materials and processes are described with relation to the non-limiting definitions and terminology included herein. These definitions and terminology are not designed to function as a limitation on the scope or practice of the disclosure, but are presented for illustrative and descriptive purposes only. While the processes or compositions are described as an order of individual steps or using specific materials, those skilled in the art will appreciate that steps or materials may be interchangeable, such that the description of the disclosure may include multiple parts or steps arranged in many ways as is readily appreciated by one of skill in the art.

It will be understood that, although the terms “first,” “second,” “third,” etc. may be used herein to describe various elements, components, regions, layers, and/or sections, these elements, components, regions, layers, and/or sections should not be limited by the use of these terms. The terms are only used to distinguish one element, component, region, layer, or section from another element, component, region, layer, or section. Thus, “a first ‘element’”, “component,” “region,” “layer,” or “section” discussed below could be termed a second (or other) element, component, region, layer, or section without departing from the teachings herein.

The terminology used herein is for the purpose of describing particular aspects of the disclosure only and is not intended to be limiting. As used herein, the singular forms “a,” “an,” and “the” are intended to include the plural forms, including “at least one” or “one or more,” unless the content clearly indicates otherwise. Additionally, as used herein, “or” means “and/or.” As used herein, the term “and/or” includes any and all combinations of one or more of the associated listed items. It will be further understood that the terms “comprises” and/or “comprising,” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Patents, publications, and applications mentioned in the specification are indicative of the levels of those skilled in the art to which the disclosure pertains. These patents, publications, and applications are incorporated herein by reference to the same extent as if each individual patent, publication, or application was specifically and individually incorporated herein by reference.

The foregoing description is illustrative of particular aspects of the disclosure, but is not meant to be a limitation upon the practice thereof.

1. A process for isolating purified water comprising:
subjecting an aqueous solution comprising a metal (M) and/or lithium (Li⁺) to a solvent extraction process or an ion exchange process in the presence of a metal extractant under conditions to remove a portion of the metal and/or a portion of the lithium from the aqueous solution to form a metal poor solution.

2. The process according to claim 1, wherein:
the aqueous solution comprises a metal (M) and lithium (Li⁺); and a portion of the metal and a portion of the lithium are removed by solvent extraction or ion exchange.

3. The process according to claim 1, wherein the metal extractant is not specific for the metal or lithium.

4. A process for isolating purified water comprising:
treating an aqueous solution comprising a metal (M), and optionally lithium (Li⁺), with an amount of an alkaline agent sufficient to convert a portion of the metal to an insoluble metal salt to form a metal poor solution.

5. The process according to claim 4, wherein the alkaline agent selectively forms the insoluble metal salt such that the metal poor solution is not lithium depleted.

6. The process according to claim 4, wherein the alkaline agent forms metal and lithium salts with lower solubility in water than the metal and lithium in the aqueous solution.

7. The process according to claim 4, wherein the alkaline agent is chosen from sodium hydroxide, potassium hydroxide, ammonium hydroxide, lithium hydroxide, and a combination of at least two of the foregoing.

8. The process according to claim 1, further comprising contacting the metal poor solution with a lithium salt forming agent to form a lithium poor solution.

9. The process for isolating purified water according to claim 1, further comprising
contacting the aqueous solution comprising lithium (Li⁺), and optionally a metal (M), with a lithium salt forming agent to form a lithium poor solution.

10. The process according to claim 9, wherein the lithium salt forming agent forms a carbonate of lithium, a silicate of lithium, an orthosilicate of lithium, or an alkylcarboxylic acid.

11. The process according to claim 1, further comprising removing at least some acid from the metal poor solution, which optionally comprises contacting the metal poor solution with an acid removing agent.

12. (canceled)

13. The process according to claim 11, wherein contact with the acid removing agent results in isolation of purified water with a pH of no greater than 8.0.

14. The process according to claim 1, wherein the metal poor solution is subjected to a salt removal process.

15. (canceled)

16. (canceled)

17. The process according to claim 1, wherein the metal poor solution comprises less than 1000 parts per million of the metal.

18. (canceled)

19. The process according to claim 1, wherein the aqueous solution is waste from a delithiation reaction, which optionally comprises delithiating a compound comprising LiNiO₂ to form the aqueous solution.

20. (canceled)

21. The process according to claim 1, wherein the aqueous solution comprises lithium and a metal, which is optionally nickel.

22. (canceled)

23. (canceled)

24. (canceled)

25. (canceled)

26. (canceled)

27. The process according to claim 1, further comprising using the purified water in a delithiation reaction comprising delithating a lithium-containing compound which optionally comprises LiNiO₂.

28. (canceled)

29. The process according to claim 9, wherein the lithium salt forming agent forms a carbonate of lithium, a silicate of lithium, an orthosilicate of lithium, or an alkylcarboxylic acid.

30. The process according to claim 9, further comprising removing at least some acid from the lithium poor solution, which optionally comprises contacting the lithium poor solution with an acid removing agent.

31. The process according to claim 9, wherein the lithium poor solution is subjected to a salt removal process.
